(19) United States
(12) Patent Application Publication
(10) Pub. No.: US 2026/0323459 A1
(43) Pub. Date: Oct. 15, 2026

(54) Roaming Through a Target Access Point

(71) Applicant: Apple Inc., Cupertino, CA (US)

(72) Inventors: Yong Ho Seok, Cupertino, CA (US); Jarkko L. Kneckt, Los Gatos, CA (US); Pooya Monajemi, Sunnyvale, CA (US); Chittabrata Ghosh, San Jose, CA (US); Morteza Mehrnoush, Hayward, CA (US); Abdel Karim Ajami, San Jose, CA (US); Ahmad Reza Hedayat, Carlsbad, CA (US); Yong Liu, Campbell, CA (US); Su Khiong Yong, Palo Alto, CA (US); Anuj Batra, Redwood City, CA (US)

(21) Appl. No.: 19/290,043

(22) Filed: Aug. 4, 2025

Related U.S. Application Data
(60) Provisional application No. 63/712,271, filed on Oct. 25, 2024.

(51) Int. Cl. H04W 36/30; H04L 5/00; H04W 12/043; H04W 36/24

(52) U.S. Cl. CPC H04W 36/305; H04L 5/0053; H04W 12/043; H04W 36/249

(57) ABSTRACT

This disclosure relates to methods for roaming through a target access point in a wireless local area network. A non-access point device can determine that a wireless link with a serving access point device is disconnected. The non-access point device can generate and transmit signaling to a target access point device that includes a request for a route switch from the serving access point device to the target access point device. The serving access point device and the target access point device can be associated with the same multi-link multi-device system. The target access point device can attempt to obtain context information for the non-access point from the serving access point device. The target access point device can generate and provide signaling to the non-access point device that includes a response to the request for the route switch.

### PRIORITY INFORMATION

This application claims priority to U.S. provisional patent application Ser. No. 63/712,271, entitled “Roaming Through a Target Access Point,” filed Oct. 25, 2024, which is hereby incorporated by reference in its entirety as though fully and completely set forth herein.

### TECHNICAL FIELD

The present application relates to wireless communication, including techniques and devices for performing roaming through a target access point in a wireless local area network architecture.

### DESCRIPTION OF THE RELATED ART

Wireless communication systems are ubiquitous. Further, wireless communication technology has evolved from voice-only communications to also include the transmission of data, such as Internet and multimedia content.

Mobile electronic devices, or stations (STAs) or user equipment devices (UEs), can take the form of smart phones or tablets that a user typically carries. One aspect of wireless communication that can commonly be performed by mobile devices can include wireless networking, for example over a wireless local area network (WLAN), which can include devices that operate according to one or more communication standards in the IEEE 802.11 family of standards. Providing strong support for mobility, potentially including for roaming between access points in a WLAN setting, can provide significant benefits for mobile devices, but can also come with additional design challenges. Accordingly, improvements in the field are desired.

### SUMMARY

Embodiments are presented herein of, inter alia, systems, apparatuses, and methods for devices to perform roaming through a target access point in a wireless local area network architecture.

A wireless device can include one or more antennas, one or more radios operably coupled to the one or more antennas, and a processor operably coupled to the one or more radios. The wireless device can be configured to establish a connection with an access point through a wireless local area network (WLAN) over one or multiple wireless links, or can be an access point configured to establish a connection with one or more other wireless devices through a WLAN over one or multiple wireless links. In some embodiments, the wireless device can operate in each of the multiple wireless links using a respective radio of the one or more radios.

According to the techniques described herein, a wireless device that becomes disconnected from its serving access point can perform seamless roaming through a target access point that is part of the same access point multi-link multi-device system. The roaming operation can include providing signaling that includes at least a route switch request, and in some instances includes a unified link addition and route switch request to the target access point. The target access point can obtain context information for the wireless device from the previous serving access point and respond to the route switch request. This can allow the wireless device to establish an association with the target access point more quickly than by using an association or fast transition procedure with the target access point, for example since the target access point can make use of the context information for the wireless device stored by the access point multi-link multi-device system, at least in some instances.

As a further possible benefit, it can be possible for the wireless device to begin transmitting uplink data to the target access point before the route switch procedure is complete, at least in some scenarios. Techniques are also described herein for one or both of the wireless device or the target access point to hold such data until any uplink data buffered by the previous serving access point has been flushed, then to provide such data to the distribution system once the flushing is complete.

The techniques described herein can be implemented in and/or used with a number of different types of devices, including but not limited to cellular phones, tablet computers, accessory and/or wearable computing devices, portable media players, base stations, access points, and other network infrastructure equipment, servers, unmanned aerial vehicles, unmanned aerial controllers, automobiles and/or motorized vehicles, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including a wireless device, according to some embodiments;

FIG. 2 is a block diagram illustrating an example wireless device, according to some embodiments;

FIG. 3 is a block diagram illustrating an example network element or access point, according to some embodiments;

FIG. 4 is a block diagram illustrating an example modem or baseband processor, according to some embodiments;

FIGS. 5-6 are flowchart diagrams illustrating example methods for performing roaming through a target access point in a wireless local area network, according to some embodiments;

FIG. 7 is a signal flow diagram illustrating example aspects of a possible seamless roaming sequence, according to some embodiments;

FIG. 8 illustrates aspects of an example wireless communication system that includes access point multi-link multi-device management, according to some embodiments;

FIG. 9 illustrates example aspects of a system in which connectivity with a serving access point is lost before seamless roaming to a target access point is complete, according to some embodiments;

FIGS. 10-13 are signal flow diagrams illustrating example aspects of possible techniques for handling attempts to perform seamless roaming through a target access point using link addition requests, according to some embodiments; and

FIGS. 14-15 are signal flow diagrams illustrating example aspects of possible techniques for handling attempts to perform seamless roaming through a target access point using route switch requests, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terminology

The following are definitions of terms used in this disclosure:

Memory Medium—Any of various types of non-transitory memory devices or storage devices. The term “memory medium” is intended to include any computer system memory or random access memory, such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), server-based computer system, wearable computer, network appliance, Internet appliance, smartphone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable, and that perform wireless communications. Examples of UE devices include mobile telephones or smart phones (e.g., iPhone™, Android™-based phones), tablet computers, portable gaming devices, laptops, wearable devices (e.g., smart watch, smart glasses, smart goggles, head-mounted display devices, and so forth), portable Internet devices, music players, data storage devices, or other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device or Station (STA)—any of various types of computer systems or devices that perform wireless communications. A wireless device can be portable (or mobile), or can be stationary or fixed at a certain location. The terms “station” and “STA” are used similarly. A UE is an example of a wireless device.

Communication Device—any of various types of computer systems or devices that perform communications, where the communications can be wired or wireless. A communication device can be portable (or mobile) or can be stationary or fixed at a certain location. A wireless device is an example of a communication device. A UE is another example of a communication device.

Base Station or Access Point (AP)—The term “Base Station” has the full breadth of its ordinary meaning, and at least includes a wireless communication station installed at a fixed location and used to communicate as part of a wireless communication system. The term “access point” (or “AP”) is typically associated with Wi-Fi-based communications and is used similarly.

Processing Element (or Processor)—refers to various elements or combinations of elements that are capable of performing a function in a device, e.g., in a communication device or in a network infrastructure device. Processors can include, for example: processors and associated memory, circuits such as an ASIC (Application Specific Integrated Circuit), portions or circuits of individual processor cores, entire processor cores, processor arrays, programmable hardware devices such as a field programmable gate array (FPGA), and/or larger portions of systems that include multiple processors, as well any of various combinations of the above.

IEEE 802.11—refers to technology based on IEEE 802.11 wireless standards such as 802.11a, 802.11b, 802.11g, 802.11n, 802.11-2012, 802.11ac, 802.11ad, 802.11ax, 802.11ay, 802.11be, and/or other IEEE 802.11 standards. IEEE 802.11 technology can also be referred to as “Wi-Fi” or “wireless local area network (WLAN)” technology.

Configured to—Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

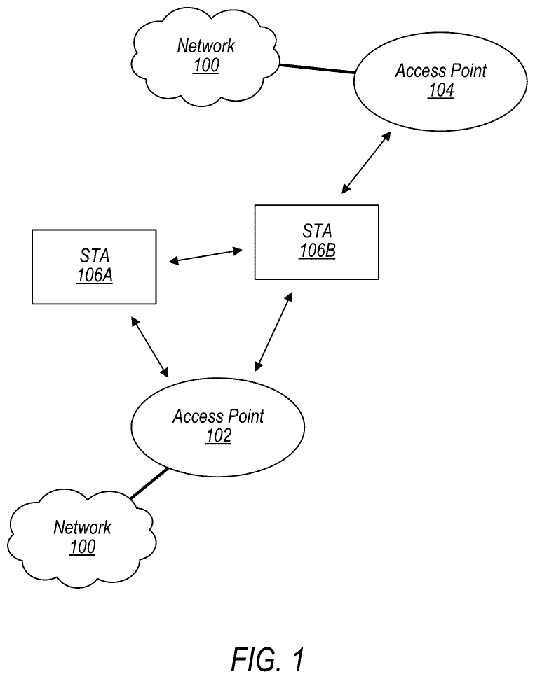

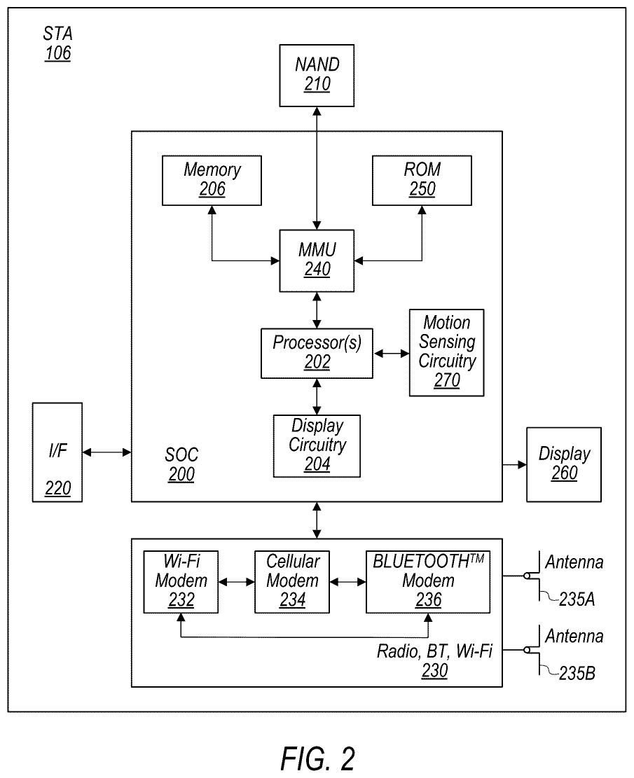

### FIGS. 1-2—Wireless Communication System

FIG. 1 illustrates an example of a wireless communication system. It is noted that FIG. 1 represents one possibility among many, and that features of the present disclosure can be implemented in any of various systems, as desired. For example, instances described herein can be implemented in any type of wireless device. The wireless communication system described below is one example.

As shown, the exemplary wireless communication system includes an access point (AP) 102, which communicates over a transmission medium with one or more wireless devices 106A, 106B, etc. Wireless devices 106A and 106B can be user devices, such as stations (STAs), non-AP STAs, UEs, or other WLAN devices.

The STA 106 can be a device with wireless network connectivity, such as a mobile phone, a hand-held device, a wearable device (e.g., such as a smart watch, smart glasses, and/or a head-mounted display device), a computer or a tablet, an unmanned aerial vehicle (UAV), an unmanned aerial controller (UAC), an automobile, or virtually any other type of wireless device. The STA 106 can include a processor (processing element) that is configured to execute program instructions stored in memory. The STA 106 can perform any of the methods described herein by executing one or more of such stored instructions. Alternatively, or in addition, the STA 106 can include a programmable hardware element, such as an FPGA (field-programmable gate array), an integrated circuit (e.g., an ASIC), a programmable logic device (PLD), and/or any of various other possible hardware components that are configured to perform (e.g., individually or in combination) any of the methods described herein, or any portion of any of the methods described herein.

The AP 102 can be a stand-alone AP or an enterprise AP, can be a base transceiver station (BTS) or cell site, and can include hardware that enables wireless communication with the STA devices 106A and 106B. The AP 102 can also be equipped to communicate with a network 100 (e.g., a core network of a service provider (e.g., a cellular service provider, an Internet service provider, and/or a carrier), a WLAN, an enterprise network, and/or another communication network connected to the Internet, among various possibilities). Thus, the AP 102 can facilitate communication among the STA devices 106 and/or between the STA devices 106 and the network 100. AP 102 can be configured to provide communications over one or more wireless technologies, such as any, any combination of, and/or all of 802.11 a, b, g, n, ac, ad, ax, ay, be and/or other 802.11 versions, and/or a cellular protocol, such as 6G, 5G and/or LTE, including in an unlicensed band.

The communication area (or coverage area) of the AP 102 can be referred to as a basic service area (BSA) or cell. The AP 102 and the STAs 106 can be configured to communicate over the transmission medium using any of various radio access technologies (RATs) or wireless communication technologies, such as Wi-Fi, LTE, LTE-Advanced (LTE-A), 5G NR, 6G, ultra-wideband (UWB), etc.

AP 102 and other similar access points (not shown) operating according to one or more wireless communication technologies can thus be provided as a network, which can provide continuous or nearly continuous overlapping service to STA devices 106A-B and similar devices over a geographic area, e.g., via one or more communication technologies. A STA can roam from one AP to another AP directly, or can transition between APs and/or network cells (e.g., such as cellular network cells).

Note that at least in some instances a STA device 106 can be capable of communicating using any of multiple wireless communication technologies. For example, a STA device 106 might be configured to communicate using Wi-Fi, LTE, LTE-A, 5G NR, 6G, Bluetooth, UWB, one or more satellite systems, etc. Other combinations of wireless communication technologies (including more than two wireless communication technologies) are also possible. Likewise, in some instances a STA device 106 can be configured to communicate using only a single wireless communication technology.

As shown, the exemplary wireless communication system can also include an access point (AP) 104, which communicates over a transmission medium with the wireless device 106B. The AP 104 also provides communicative connectivity to the network 100. Thus, wireless devices can connect to either or both of AP 102 (or another cellular base station) and the access point 104 (or another access point) to access the network 100. For example, a STA can roam from AP 102 to AP 104, e.g., based on one or more factors, such as mobility, coverage, interference, and/or capabilities. Note that it can also be possible for the AP 104 to provide access to a different network (e.g., an enterprise Wi-Fi network, a home Wi-Fi network, etc.) than the network to which the AP 102 provides access.

The STAs 106A and 106B can include handheld devices such as smart phones or tablets, wearable devices such as smart watches, smart glasses, head-mountable display devices, and/or can include any of various types of devices with wireless communication capability. For example, one or more of the STAs 106A and/or 106B can be a wireless device intended for stationary or nomadic deployment, such as an appliance, measurement device/sensor, control device, etc.

The STA 106B can also be configured to communicate with the STA 106A. For example, the STA 106A and STA 106B can be capable of performing direct device-to-device (D2D) communication. Note that such direct communication between STAs can also or alternatively be referred to as peer-to-peer (P2P) communication. The direct communication can be supported by the AP 102 (e.g., the AP 102 can facilitate discovery, among various possible forms of assistance), or can be performed in a manner unsupported by the AP 102. Such P2P communication can be performed using 3GPP-based D 2D communication techniques, Wi-Fi-based P2P communication techniques, UWB, BT, and/or any of various other direct communication techniques, according to various examples.

The STA 106 can include one or more devices or integrated circuits for facilitating wireless communication, potentially including a Wi-Fi modem, cellular modem, and/or one or more other wireless modems. The wireless modem(s) can include one or more processors (processor elements) and various hardware components as described herein. The STA 106 can perform any of (or any portion of) the methods described herein by executing instructions on one or more programmable processors. For example, the STA 106 can be configured to perform techniques for roaming through a target access point in a wireless communication system, such as according to the various methods described herein. Alternatively, or in addition, the one or more processors can be one or more programmable hardware elements such as an FPGA (field-programmable gate array), application-specific integrated circuit (ASIC), or other circuitry, that is configured to perform any of the methods described herein, or any portion of any of the methods described herein. The wireless modem(s) described herein can be used in a STA device as defined herein, a wireless device as defined herein, or a communication device as defined herein. The wireless modem described herein can also be used in an AP, a base station, a pico cell, a femto cell, and/or other similar network side device.

The STA 106 can include one or more antennas for communicating using two or more wireless communication protocols or radio access technologies (RATs). In some instances, the STA device 106 can be configured to communicate using a single shared radio. The shared radio can couple to a single antenna, or can couple to multiple antennas (e.g., for MIMO) for performing wireless communications. Alternatively, the STA device 106 can include two or more radios, each of which can be configured to communicate via a respective wireless link. Other configurations are also possible.

### FIG. 2—Example Block Diagram of a STA Device

FIG. 2 illustrates an example block diagram of a STA device, such as STA 106. In some instances, the STA 106 can additionally or alternatively be referred to as a UE 106. STA 106 also can be referred to as a non-AP STA 106. As shown, the STA 106 can include a system on chip (SOC) 200, which can include one or more portions configured for various purposes. Some or all of the various illustrated components (and/or other device components not illustrated, e.g., in variations and alternative arrangements) can be “communicatively coupled” or “operatively coupled,” which terms can be taken herein to mean components that can communicate, directly or indirectly, when the device is in operation.

In some instances, the STA 106 can be configured as a Multi-Link Device (MLD). In such instances, the STA 106 (e.g., one or more radios of the STA 106) can be configured for concurrent data transmission and reception in multiple channels across a single band and/or multiple frequency bands (e.g., such as a 2.4 GHz band, a 5 GHz band, and/or a 6 GHz band). As such, the STA 106 (e.g., one or more radios of the STA 106) can be configured to perform Multi-Link Operation (MLO). For example, the STA 106 (e.g., one or more radios of the STA 106) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

As shown, the SOC 200 can include processor(s) 202, which can execute program instructions for the STA 106, and display circuitry 204, which can perform graphics processing and provide display signals to the display 260. The SOC 200 can also include motion sensing circuitry 270, which can detect motion of the STA 106 in one or more dimensions, for example using a gyroscope, accelerometer, and/or any of various other motion sensing components. The processor(s) 202 can also be coupled to memory management unit (MMU) 240, which can be configured to receive addresses from the processor(s) 202 and translate those addresses to locations in memory (e.g., memory 206, read only memory (ROM) 250, flash memory 210). The MMU 240 can be configured to perform memory protection and page table translation or set up. In some instances, the MMU 240 can be included as a portion of the processor(s) 202.

As shown, the SOC 200 can be coupled to various other circuits of the STA 106. For example, the STA 106 can include various types of memory (e.g., including NAND flash 210), a connector interface 220 (e.g., for coupling to a computer system, dock, charging station, etc.), the display 260, and wireless communication circuitry 230 (e.g., for LTE, LTE-A, 5G NR, 6G, Bluetooth, Wi-Fi, NFC, GPS, UWB, peer-to-peer (P2P), device-to-device (D2D), etc.).

The STA 106 can include at least one antenna, and in some instances can include multiple antennas, e.g., 235A and 235B, for performing wireless communication with access points, base stations, wireless stations, and/or other devices. For example, the STA 106 can use antennas 235A and 235B to perform the wireless communication. As noted above, the STA 106 can, in some examples, be configured to communicate wirelessly using a plurality of wireless communication standards or radio access technologies (RATs).

The wireless communication circuitry 230 can include a Wi-Fi modem 232, a cellular modem 234, and a Bluetooth modem 236. Note that one or more of the Wi-Fi modem 232, the cellular modem 234, and/or the Bluetooth modem 236 can be configured for MLO, e.g., as described above. The Wi-Fi modem 232 is for enabling the STA 106 to perform Wi-Fi or other WLAN communications, e.g., on an 802.11 network. The Bluetooth modem 236 is for enabling the STA 106 to perform Bluetooth communications. The cellular modem 234 can be capable of performing cellular communication according to one or more cellular communication technologies, e.g., in accordance with one or more 3GPP specifications.

As described herein, STA 106 can include hardware and software components for implementing aspects of this disclosure. For example, one or more components of the wireless communication circuitry 230 (e.g., Wi-Fi modem 232, cellular modem 234, BT modem 236) of the STA 106 can be configured to implement part or all of the methods for performing roaming through a target access point described herein, e.g., by a processor executing program instructions stored on a memory medium (e.g., a non-transitory computer-readable memory medium), a processor configured as an FPGA (Field Programmable Gate Array), and/or using dedicated hardware components, which can include an ASIC (Application Specific Integrated Circuit).

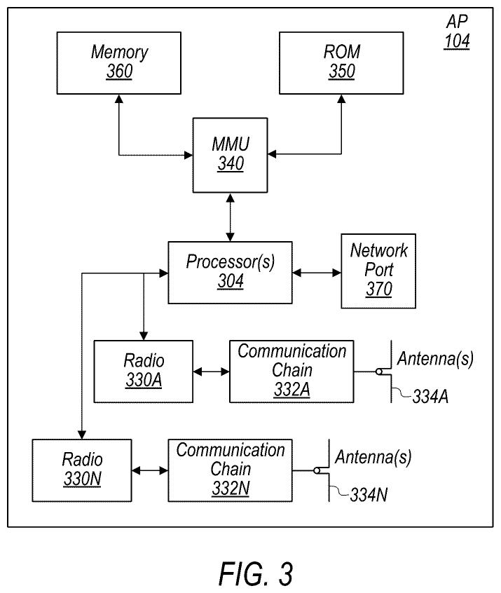

### FIG. 3—Block Diagram of an Access Point

FIG. 3 illustrates an example block diagram of an access point (AP) 104. In some instances (e.g., in an 802.11 communication context), the AP 104 can also be referred to as a station (STA), and possibly more particularly as an AP STA. It is noted that the AP of FIG. 3 is merely one example of a possible access point. As shown, AP 104 can include processor(s) 304, which can execute program instructions for the AP 104. The processor(s) 304 can also be coupled to memory management unit (MMU) 340, which can be configured to receive addresses from the processor(s) 304 and translate those addresses to locations in memory (e.g., memory 360 and read only memory (ROM) 350) or to other circuits or devices.

In some instances, the AP 104 can be configured as a Multi-Link Device (MLD). In such instances, the AP 104 (e.g., one or more radios of the AP 104) can be configured for concurrent data transmission and reception in multiple channels across a single band and/or multiple frequency bands (e.g., such as a 2.4 GHz band, a 5 GHz band, and/or a 6 GHz band). As such, the AP 104 (e.g., one or more radios of the AP 104) can be configured to perform Multi-Link Operation (MLO). For example, the AP 104 (e.g., one or more radios of the AP 104) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The AP 104 can include at least one network port 370. The network port 370 can be configured to couple to a network and provide multiple devices, such as STA devices 106, with access to the network, for example as described herein above in FIG. 1.

The network port 370 (or an additional network port) can also or alternatively be configured to couple to a cellular network, e.g., a core network of a cellular service provider (e.g., a carrier and/or cellular carrier). The core network can provide mobility related services and/or other services to a plurality of devices, such as STA devices 106. In some cases, the network port 370 can couple to a telephone network via the core network, and/or the core network can provide a telephone network (e.g., among other STA devices serviced by the cellular service provider).

The AP 104 can include one or more radios 330A-330N, which can be coupled to one or more respective communication chains and at least one antenna 334, and possibly multiple antennas. The antenna(s) 334 can be configured to operate, in conjunction with one or more other components, as a wireless transceiver and can be further configured to communicate with STA devices 106 via radios 330A-330N. Note that one or more of the radios 330A-330N can be configured for MLO, e.g., as described above. The antenna(s) 334A-N communicate with one or more respective radios 330A-N via communication chains 332A-N. Communication chains 332 can be receive chains, transmit chains, or both. The radios 330A-N can be configured to communicate in accordance with various wireless communication standards, including, but not limited to, LTE, LTE-A, 5G NR, 6G, UWB, Wi-Fi, BT, etc. The AP 104 can be configured to operate on multiple wireless links using the one or more radios 330A-N. In some implementations, each radio can be used to operate on a respective wireless link.

The AP 104 can be configured to communicate wirelessly using multiple wireless communication standards. In some instances, the AP 104 can include multiple radios, which can enable the network entity to communicate according to multiple wireless communication technologies. For example, as one possibility, the AP 104 can include a 4G or 5G radio for performing communication according to a 3GPP wireless communication technology, as well as a Wi-Fi radio for performing communication according to one or more Wi-Fi specifications. In such a case, the AP 104 can be capable of operating as both a cellular base station and a Wi-Fi access point. As another possibility, the AP 104 can include a multi-mode radio that is capable of performing communications according to any of multiple wireless communication technologies (e.g., 5G NR and Wi-Fi, 5G NR and LTE, etc.). As still another possibility, the AP 104 can be configured to act exclusively as a Wi-Fi access point, e.g., without cellular communication capability.

As described further herein, the AP 104 can include hardware and software components for implementing or supporting implementation of features described herein, such as performing roaming through a target access point, among various other possible features. The processor 304 of the AP 104 can be configured to implement, or support implementation of, part or all of the methods described herein, e.g., by executing program instructions stored on a memory medium (e.g., a non-transitory computer-readable memory medium) to operate multiple wireless links using multiple respective radios. Alternatively, the processor 304 can be configured as a programmable hardware element, such as an FPGA (Field Programmable Gate Array) or ASIC (Application Specific Integrated Circuit), or a combination thereof. Alternatively (or in addition) the processor 304 of the AP 104, in conjunction with one or more of the other components 330, 332, 334, 340, 350, 360, 370 can be configured to implement, or support implementation of, part or all of the features described herein.

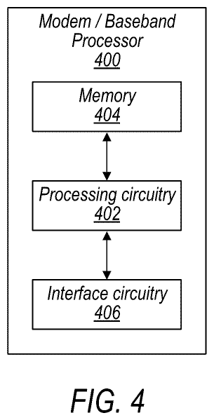

### FIG. 4—Block Diagram of a Modem or Baseband Processor

FIG. 4 illustrates an example block diagram of a modem 400, which can also be referred to as baseband processor 400. The modem 400 can provide signal processing functionality for one or more wireless communication technologies, such as Wi-Fi, Bluetooth, and/or a cellular (e.g., 3GPP) communication technology. Thus, as one possibility, modem 400 can represent a Wi-Fi modem; for example, the modem 400 illustrated in FIG. 4 can represent one possible example of Wi-Fi modem 232 illustrated in FIG. 2. As another possibility, modem 400 can represent a cellular modem or cellular baseband processor; for example, the modem 400 illustrated in FIG. 4 can represent one possible example of cellular modem 234 illustrated in FIG. 2. As a still further possibility, modem 400 can represent a Bluetooth modem; for example, the modem 400 illustrated in FIG. 4 can represent one possible example of Wi-Fi modem 236 illustrated in FIG. 2. In some instances, the modem 400 could implement functionality for supporting communication according to multiple wireless communication technologies. At least in some instances, the modem 400 can run a real-time operating system, e.g., for facilitating performance of timing-dependent wireless communication functionality.

In some instances, the modem 400 can be configured for concurrent data transmission and reception in multiple channels across a single band and/or multiple frequency bands (e.g., such as a 2.4 GHz band, a 5 GHz band, and/or a 6 GHz band). As such, the modem 400 can be configured to perform Multi-Link Operation (MLO). For example, the modem 400 can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The modem 400 can include processing circuitry 402, which could include one or more processor cores, ASICs, programmable hardware elements, digital signal processors, and/or other processing elements. The processing circuitry can be capable of preparing baseband signals for up-conversion and transmission by radio circuitry of a wireless device, and/or for processing baseband signals received and down-converted by radio circuitry of a wireless device. Such processing could include signal modulation, encoding, decoding, etc., among various possible functions. The processing circuitry can also or alternatively be capable of performing functionality for one or more baseband and/or other layers/sublayers of a protocol stack for the wireless communication technology (or technologies) implemented by the modem 400, such as physical layer (PHY) functionality, media access control (MAC) functionality, logical link control (LLC) functionality, radio resource control (RRC) functionality, radio link control (RLC) functionality, etc. In some instances, the modem 400 can itself include at least some radio circuitry (e.g., for performing the conversion of input baseband signals to radio frequency signals and/or of input radio frequency signals to baseband signals). Alternatively, or in addition, some or all such functions can be performed by separate radio/transceiver components of the wireless device.

The modem 400 can also include memory 404, which can include a non-transitory computer-readable memory medium. The memory 404 can include program instructions for performing signal processing and/or any of various possible general processing functions. The processing circuitry 402 can be capable of executing the program instructions stored in the memory 404. The memory 404 can also store data generated and/or used during processing performed by the processing circuitry 402.

As shown, the modem 400 can further include interface circuitry, e.g., for communicating with other components of a wireless device (such as STA 106 or AP 104 illustrated in FIGS. 1-3), such as an application processor, radio/transceiver circuitry, and/or any of various other components. Such interfaces can be implemented in any of various ways; for example, as one possibility, the modem 400 can have a direct interface with transceiver circuitry of a wireless device, and can have an additional indirect interface with an application processor and/or other components of the wireless device by way of a system bus. Other configurations are also possible.

In at least some instances, the hardware and software components of the modem 400 can be configured to implement or support implementation of features described herein, such as performing roaming through a target access point, among various other possible features. For example, the processing circuitry 402 of the modem 400 can be configured to implement, or support implementation of, part or all of the methods described herein, e.g., by executing program instructions stored on memory (e.g., non-transitory computer-readable memory medium) 404 and/or using dedicated hardware components.

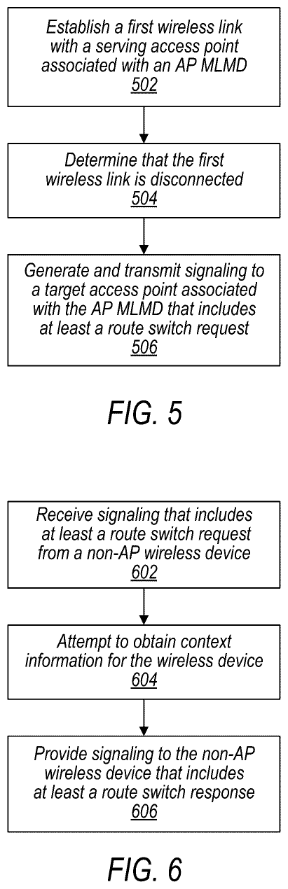

### FIGS. 5-6—Roaming Through a Target Access Point

FIGS. 5-6 are flowchart diagrams illustrating methods for supporting performing roaming through a target access point in a WLAN, according to some embodiments. In various embodiments, some of the elements of the methods shown can be performed concurrently, in a different order than shown, can be substituted for by one or more other method elements, or can be omitted. Additional method elements can also be performed as desired.

Aspects of the methods of FIGS. 5-6 can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated method elements and/or other method elements.

Note that while at least some elements of the methods of FIGS. 5-6 are described in a manner relating to the use of communication techniques and/or features associated with IEEE 802.11 specification documents, such description is not intended to be limiting to the disclosure, and aspects of the methods of FIGS. 5-6 can be used in any suitable wireless communication system, as desired. At least according to some embodiments, the methods of FIGS. 5-6 can be performed in conjunction with each other; for example, the method of FIG. 5 could be performed by a non-access point (or “STA”) wireless device in conjunction with a roaming target access point wireless device that is performing the method of FIG. 6, as one possibility. As shown, the methods can operate as follows.

An access point (AP) wireless device can provide one or more basic service sets (BSSs). In some embodiments, the AP wireless device may be an AP multi-link device (MLD), which may be capable of providing a BSS on each of multiple links, such as on a 2.4 GHz link, a 5 GHz link, and/or a 6 GHz link. The AP wireless device may operate in a standalone manner or may be affiliated with one or more other devices, e.g., as part of a larger network. For example, the AP wireless device could be a member of (or otherwise associated with) an AP multi-link multi-device (MLMD) system, which could include multiple AP wireless devices, in some embodiments.

The AP wireless device and a non-AP (or “STA”) wireless device can establish a wireless association (502), which can include establishing one or more wireless links (e.g., a 2.4 GHz link, a 5 GHz link, and/or a 6 GHz link). Such wireless associations can be established using Wi-Fi, wireless communication techniques that are based at least in part on Wi-Fi, and/or any of various other wireless communication technologies, according to various embodiments. For example, an AP wireless device may provide (e.g., broadcast) beacon transmissions including information for associating with the AP wireless device, and one or more other wireless devices (e.g., non-AP wireless devices) may request to associate with the AP wireless device using the information provided in the beacon transmissions, as one possibility. Use of (e.g., unicast) probe requests and probe responses may also be possible, in some instances, for a non-AP wireless device to obtain AP parameters and/or other system information for the AP wireless device. Variations and/or other techniques for establishing an association are also possible.

The AP wireless device may provide wireless local area network functionality to associated wireless devices, at least according to some embodiments. As part of the wireless local area network functionality, it may be possible for wireless devices to contend for medium access and perform wireless transmissions on one or more wireless communication channels (each of which could possibly include multiple sub-channels) according to general provisions of the wireless communication technology in use by the wireless local area network (e.g., Wi-Fi, as one possibility) and/or network specific parameters configured by the AP wireless device. Thus, the AP wireless device can operate as a serving AP wireless device for the non-AP wireless device.

For example, at least according to some embodiments, performing a downlink data transmission from a serving AP wireless device to a non-AP wireless device in such a wireless local area network can include contending for medium access (e.g., to avoid collisions and potential interference), and, once medium access is obtained, transmitting a physical layer (PHY) protocol data unit (PPDU) (which can also be referred to as a downlink frame) to the destination wireless device. The downlink frame can include physical layer signaling (e.g., including a preamble for frame detection, timing and frequency synchronization, channel estimation, etc., and header information indicating packet configuration, format, data rates, channel occupation time, and/or other control information) and data (which can in turn include one or more higher layer packets, such as media access control (MAC) protocol data units (MPDUs). Note that other types of transmissions (e.g., including triggered uplink frames, enhanced distributed channel access (EDCA) uplink frames, transmission opportunity (TXOP) sharing for peer-to-peer (P2P) communications, etc.) can also be possible in such a wireless local area network.

The wireless link between the non-AP wireless device and the serving AP wireless device can become disconnected. This could occur due to mobility or other factors that impact channel conditions between the non-AP wireless device and the serving AP wireless device, operation in a power save or sleep mode for a certain period of time, and/or any of various other possible reasons. The non-AP wireless device can determine that the wireless link is disconnected (504). The determination can be based on any of various possible configured indicators, such as a rapid signal strength decrease with the serving AP wireless device (e.g., received signal strength indicator (RSSI) dropping more than a certain amount within a certain period of time, as one possibility), excessive frame loss (e.g., a certain number of consecutive failures of uplink frames, as one possibility), etc.

At least according to some embodiments, a maximum idle period may be enforced among AP MLDs associated with the same AP MLMD, e.g., such that if the non-AP wireless device does not engage in any frame exchange with an AP MLD in the AP MLMD during the maximum idle period, the non-AP wireless device's context information can be discarded, and the non-AP wireless device can be disconnected from the AP MLMD. Accordingly, at least in some instances, the non-AP wireless device can track whether the configured maximum idle period has expired for the non-AP wireless device.

The non-AP wireless device can generate and transmit, to a target AP wireless device (e.g., another AP MLD), signaling that includes at least a request for a route switch from the serving AP wireless device to the target AP wireless device. Note that the target AP wireless device can be selected for roaming based on scanning operations by the non-AP wireless device (e.g., to identify and determine signal strength and/or other parameters for the target AP wireless device), discovery communications with the serving AP wireless device and/or target AP wireless device (e.g., reduced neighbor report information, basic service set transition management (BTM) information, multi-link (ML) probing messages, etc.), and/or for any of various other possible reasons. The target AP wireless device can be associated with (e.g., a member of) the same MLMD as the serving AP wireless device, which can also be a consideration in selecting the target AP wireless device as the roaming target for the non-AP wireless device, at least according to some embodiments. Generation and transmission of the signaling that includes at least the request for the route switch from the serving AP wireless device to the target AP wireless device can also be based at least in part on a determination that the configured maximum idle period for the non-AP wireless device for the AP MLMD associated with the serving AP wireless device has not yet reached expiry. For example, if the configured maximum idle period has reached expiry, the non-AP wireless device can determine to perform an association procedure with the target AP wireless device rather than a roaming procedure (e.g., since context information that would be used during the roaming procedure can be discarded after this expiry, which could lead to roaming rejection), and proceed with the association procedure accordingly.

In some instances, the signaling generated and transmitted to the target AP wireless device by the non-AP wireless device can include a unified link addition and route switch request. In other words, the signaling can include the functionality of both a link addition request and a route switch request, e.g., to potentially reduce the overall roaming time to the target AP wireless device. The unified link addition and route switch request can thus facilitate transfer of both static and dynamic context information for the non-AP wireless device between the serving AP wireless device and the target AP wireless device. Key establishment and resource negotiation (block acknowledgement, stream classification service, etc.) can be performed, and information identifying the serving AP wireless device (e.g., AP MLD MAC address information) can be provided. The unified link addition and route switch request frame can cause any downlink packets buffered in the serving AP wireless device to be delivered to the STA MLD through data forwarding, e.g., if it is supported between the AP wireless devices. The unified link addition and route switch request frame can also request that uplink packet flushing be performed by the serving AP wireless device, e.g., such that any uplink packets from the non-AP wireless device that are being held by the serving AP wireless device can be released to the distribution system. The unified link addition and route switch request frame can also include distribution system mapping update information to update the distribution system mapping for the non-AP wireless device to the target AP wireless device, in some embodiments.

Key establishment can be performed in multiple possible ways. As one possibility, pairwise transient key (PTK) negotiation messages can be exchanged as a “message 1” and “message 2” before unified link addition and route switch exchange is performed, such that the unified link addition and route switch exchange can be protected and provide PTK verification. As another possibility, the unified link addition and route switch exchange can include PTK negotiation, and PTK verification can be performed after unified link addition and route switch exchange is performed, e.g., using a “message 3” and “message 4.”

In some instances, the non-AP wireless device can perform a link addition request/response exchange with the serving AP wireless device to add a wireless link between the non-AP wireless device and the target AP wireless device before the wireless link between the non-AP wireless device and the serving AP wireless device is disconnected. In such a scenario, it can be the case that the signaling generated and transmitted to the target AP wireless device by the non-AP wireless device includes a route switch request (e.g., without a link addition request, since link addition has already been performed). In this case, frame protection for the route switch request frame can be provided by use of a PTK established during the link addition procedure. The route switch request frame can include information identifying the serving AP wireless device (e.g., AP MLD MAC address information) to facilitate transfer of dynamic context information for the non-AP wireless device between the serving AP wireless device and the target AP wireless device. The route switch request frame can also request that downlink data forwarding and/or uplink packet flushing be performed by the serving AP wireless device, e.g., such that any uplink packets from the non-AP wireless device that are being held by the serving AP wireless device can be released to the distribution system. The route switch request frame can also include distribution system mapping update information to update the distribution system mapping for the non-AP wireless device to the target AP wireless device, in some embodiments.

As another possibility, even if a link addition request/response exchange with the serving AP wireless device to add a wireless link between the non-AP wireless device and the target AP wireless device before the wireless link between the non-AP wireless device and the serving AP wireless device is disconnected, it can be possible to perform a unified link addition and route switch exchange between the non-AP wireless device and the target AP wireless device. Such an approach can potentially include some duplicated signaling (e.g., some link addition signaling may be performed twice, in some instances), but using the same signaling framework for performing roaming through a target AP wireless device regardless of whether link addition has already been performed with the serving AP wireless device can also potentially reduce implementation complexity for either or both of AP and non-AP wireless devices.

The target AP wireless device can receive, from the non-AP wireless device, signaling that includes at least a request for a route switch from a serving AP wireless device to the target AP wireless device (602). The signaling can include a unified link addition and route switch request, or a route switch request without a link addition request, e.g., as described herein with respect to FIG. 5, among various possibilities. Thus, at least according to some embodiments, the signaling can include any or all of key establishment information, resource negotiation information, information identifying the serving AP wireless device, a request that uplink packet flushing be performed by the serving AP wireless device, distribution system mapping update information, and/or any of various other signaling elements.

The target AP wireless device can attempt to obtain context information for the non-AP wireless device from the serving AP wireless device (604). This can include generating and providing, to the serving AP wireless device, signaling that includes at least a request for context information for the non-AP wireless device. Dynamic context information (e.g., sequence number and packet number information) and possibly static context information (e.g., capability and parameter information) for the non-AP wireless device can be requested, e.g., possibly depending on whether any context for the non-AP wireless device is already available at the target AP wireless device, such as from a previously performed link addition procedure. The target AP wireless device can also indicate to the serving AP wireless device if the non-AP wireless device requests uplink data flushing and/or downlink data forwarding from the serving AP wireless device, in some instances.

The serving AP wireless device can provide the requested context information (e.g., if available) to the target AP wireless device, and perform the requested uplink data flushing and/or downlink data forwarding, e.g., if applicable. If uplink data flushing is requested and performed, the serving AP wireless device can also provide an indication to the target AP wireless device that the uplink data flushing is complete.

The target AP wireless device can generate and transmit, to the non-AP wireless device, signaling that includes at least a response to the request for the route switch (606). The signaling can include a unified link addition and route switch response (e.g., if a unified link addition and route switch request was received), or a route switch response without a link addition response (e.g., if a route switch request without a link addition request was received), among various possibilities.

If the dynamic (and possibly static, e.g., if needed) context transfer for the non-AP wireless device is completed successfully, the target AP wireless device can perform a distribution system mapping update for the non-AP wireless device, and provide a response to the request for the route switch that accepts the route switch request. The route switch response frame can provide status code information and dynamic operating parameters for the target AP wireless device, and/or any of various other types of information, e.g., to complete establishment of the wireless association (e.g., including one or more wireless links) between the non-AP wireless device and the target AP wireless device.

If no context information is available for the non-AP wireless device (e.g., due to a maximum idle period having been exceeded or for any of various other possible reasons), the target AP wireless device can provide a response to the request for the route switch that rejects the route switch request, at least according to some embodiments. In such a case, the non-AP wireless device can potentially fall back to use of an association procedure to establish a wireless association with the target AP wireless device.

Note that, during the roaming procedure with the target AP wireless device (e.g., after the signaling that includes at least the request for the route switch is transmitted and before the signaling that includes at least the response to the request for the route switch is transmitted), it can be possible for the non-AP wireless device to perform uplink data transmission with the target AP wireless device, at least according to some embodiments. The packet number and sequence number for the uplink data can be initialized to 0, in some instances. The target AP wireless device can be configured to hold the uplink data until the serving AP wireless device has completed uplink data flushing. The serving AP wireless device can provide an indication to the target AP wireless device once uplink data flushing is complete, and based at least in part on such an indication, the target AP wireless device can provide the held uplink data to the distribution system.

Alternatively, or in addition, the non-AP wireless device can influence when the target AP wireless device releases the uplink data by creating a gap in the uplink packet sequence space, for example by starting the sequence number of the first uplink frame transmitted from 1, while the sequence number space is initialized at 0. In this scenario, after a route switch response accepting the route switch request is received and the wireless link(s) with the target AP wireless device are established, the non-AP wireless device can generate and provide a block acknowledgement request to the target AP wireless device, which can move the receive window forward for the target AP wireless device. The target AP wireless device can then move its receive window forward, which can eliminate the gap in the sequence number space and trigger release of the held uplink data.

Thus, according to the methods of FIGS. 5-6, it can be possible to for a wireless device to perform roaming through a target access point, which can reduce the impact of service interruptions in scenarios when a wireless link with a serving access point is disconnected before roaming to the target access point is completed, among various possible benefits, at least according to some embodiments.

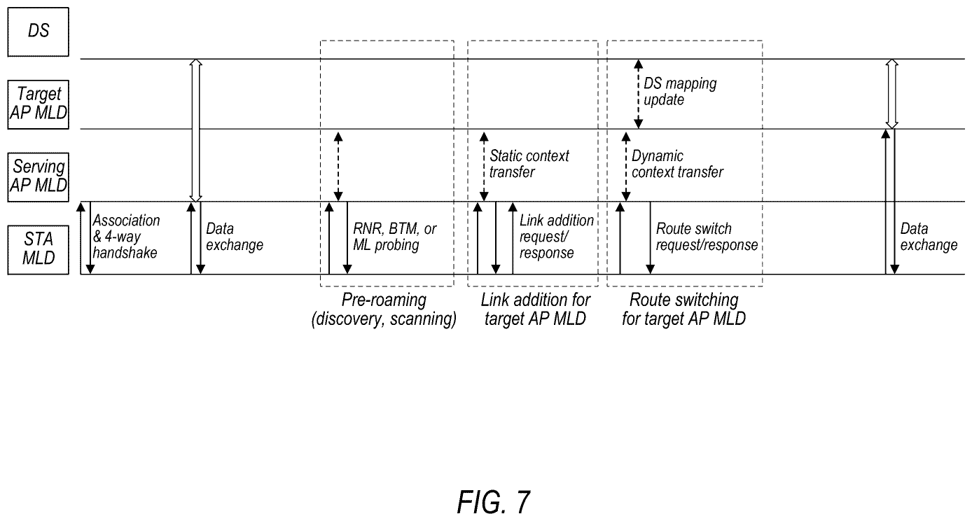

### FIGS. 7-15 and Additional Information

FIGS. 7-15 illustrate further aspects that might be used in conjunction with the methods of FIGS. 5-6. It should be noted, however, that the exemplary details illustrated in, and described with respect to, FIGS. 7-15 are not intended to be limiting to the disclosure as a whole: numerous variations and alternatives to the details provided herein below are possible and should be considered within the scope of the disclosure.

Access point facilitated roaming in a Wi-Fi based communication system, which can also sometimes be referred to as seamless roaming, can allow a wireless device to quickly transition from active association with one AP device to another AP device. FIG. 7 is a signal flow diagram illustrating example aspects of one such possible roaming sequence, according to some embodiments. As shown, a STA MLD can perform association and 4-way handshake with a serving AP MLD. The STA MLD and the serving AP MLD can perform data exchange, potentially including exchange of data that is received into and/or sent out of the distribution system (DS) for the serving AP MLD and the STA MLD.

The STA MLD and the serving AP MLD can perform pre-roaming activity, which can include scanning and/or performing discovery of neighbor AP devices via reduced neighbor report (RNR), basic service set transition management (BTM), and/or multi-link (ML) probing messages, among various possibilities. These activities can help the STA MLD prepare for the possibility that roaming to a neighbor AP device is advantageous, e.g., due to mobility, congestion, wireless medium condition changes, and/or for any other reason, by obtaining signal strength information, capability information, and/or other types of information for neighbor AP devices.

To further prepare for possible roaming, the STA MLD can exchange link addition request and response messages to add a link with a target AP MLD. The serving AP MLD can provide static context transfer (e.g., MAC and PHY capability information, etc.) for the STA MLD to the target AP MLD.

Once a decision to roam to the target AP MLD has been made, the STA MLD and the serving AP MLD can exchange route switch and response messages to accomplish the STA's roaming from the serving AP MLD to the target AP MLD. The serving AP MLD can provide dynamic context transfer (e.g., sequence number information, packet number information, etc.) for the STA MLD to the target AP MLD. The target AP MLD can also provide DS mapping update to the entity providing DS functionality. After the route switching, the STA MLD and the target AP MLD can perform data exchange, potentially including exchange of data that is received into and/or sent out of the DS.

Splitting the link addition and route switching aspects of roaming, such as is performed in the example scenario of FIG. 7, can reduce the time to perform the route switching, which can potentially improve uplink Quality of Service (QoS), at least according to some embodiments.

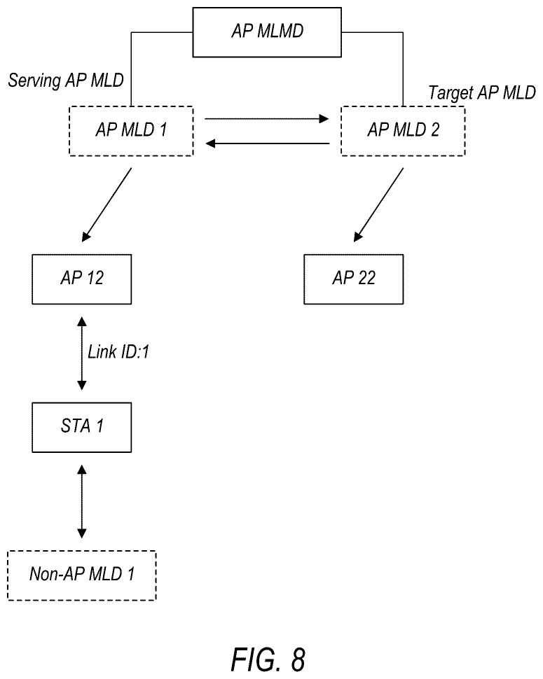

To support such seamless roaming operation, it can be the case that an AP multi-link multi-device (MLMD) management entity is deployed in a wireless communication system. FIG. 8 illustrates example aspects of one such possible system. As shown, the AP MLMD can provide a common management entity for roaming for non-collocated APs affiliated to unique AP MLDs. In other words, an AP can be affiliated to an AP MLD, which can be a member of an AP MLMD. The AP MLMD could be provided, for example, for a per-floor network of a building. The AP MLMD can further operate within a mobility domain (MD) that includes one or multiple AP MLMDs. Continuing the previous example, such a MD could be provided for a building network that includes AP MLMDs operating for each per-floor network, in some embodiments.

For the context of roaming operation, a serving AP MLD in such a network can be an AP MLD that is a member of an AP MLMD to which a non-AP MLD sends an initial association request frame to set up at least one link, while an AP MLD that is a member of the AP MLMD and to which a non-AP MLD decides to roam from the serving AP MLD can be referred to as a target AP MLD. Once a roaming operation is completed, the AP MLD that was considered the target AP MLD for the roaming operation may be considered the serving AP MLD, e.g., for a subsequent roaming operation, at least in some embodiments.

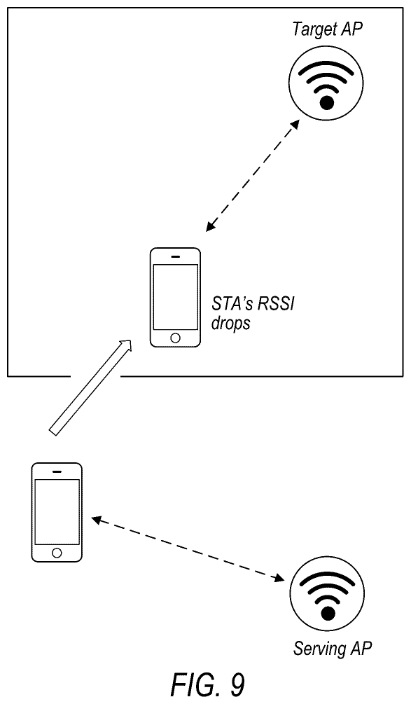

In the scenario of FIG. 7, the link addition and route switch request messages from a non-AP MLD that is performing roaming are directed to the serving AP MLD. However, when initiating seamless roaming to a target AP MLD, it can be possible that connectivity with the current serving AP MLD is not guaranteed. For example, in Wi-Fi-based networks, there can be sudden RSSI drops (e.g., due to concrete walls, elevator metal shafts, etc.), which can lead to connectivity disruption. FIG. 9 illustrates aspects of an example scenario in which serving AP connectivity can degrade or be lost prior to competing seamless roaming operation, according to some embodiments. Additionally, a STA could operate in a long-term sleep mode, and when the STA wakes up from the power save mode, its RSSI with the serving AP may have dropped significantly. At least in such scenarios, it can be beneficial to provide an alternative roaming procedure that does not run through the current serving AP MLD.

Accordingly, roaming scenarios are described herein in which a STA MLD can perform seamless roaming directly with a target AP MLD. The techniques described herein include options for handling scenarios in which the STA MLD can exchange link addition request and response and/or route switch request and response directly with the target AP MLD, as well as scenarios in which the STA MLD can exchange link addition request and response through the serving AP MLD and route switch request and response directly with the target AP MLD, according to various embodiments.

When a STA MLD associates with an AP MLD that is a member of an MLMD, the STA's state (e.g., association, BA setup, security key, stream classification service, etc.) can be accessed by another AP MLD that is a member of the same MLMD. Such maintenance can be implemented using a central logical entity or a distributed logical entity, for example. At least in some embodiments, a common parameter (e.g., “MaxIdlePeriod”) can be defined among the AP MLDs affiliated with the same MLMD, such that if a STA MLD does not engage in any frame exchange during a certain period of time (e.g., as defined by the MaxIdlePeriod parameter), the STA MLD's information is discarded, and the STA MLD is disconnected from the MLMD.

For a STA MLD for which the link with the serving AP MLD is disconnected, (e.g., if the disconnection time with the serving AP MLD exceeds the MaxIdlePeriod of the MLD that maintains the association status), it can be the case that a STA MLD is expected to not initiate a link addition procedure with the target AP MLD, but to instead fall back to a basic association or fast transition (FT) procedure to associate with that AP MLD. Accordingly, in case a STA MLD does initiate a link addition procedure with a target AP MLD even though the MaxIdlePeriod of the serving AP MLD has expired, the target AP MLD can reject such a link addition request frame, e.g., based on attempting to validate it through the serving AP MLD. In some embodiments, such behavior can further be specified as mandatory according to a wireless communication standard with which the AP MLD complies.

For a STA MLD for which the MaxIdlePeriod of the MLD that maintains the association status has not yet expired, it can be possible, according to the techniques described herein, for the STA MLD to exchange the link addition request and response directly with the target AP MLD. In a scenario in which the link addition procedure has not yet been established with the target AP MLD through the serving AP MLD, the STA MLD may take longer to roam to the target AP MLD; for example, key establishment, static context transfer, and resource (e.g., BA, SCS) negotiation can be needed in such a case. To reduce packet loss and roaming time, it could be the case that the link addition request frame includes the route switch request functionality in such a case. This could include providing the serving AP MLD's MAC address to support request of the transfer of dynamic context (e.g., SN, BA scoreboard, etc.), UL packet flushing and/or DL packet forwarding request of the serving AP MLD, and/or DS mapping update at the target AP MLD, among various possibilities.

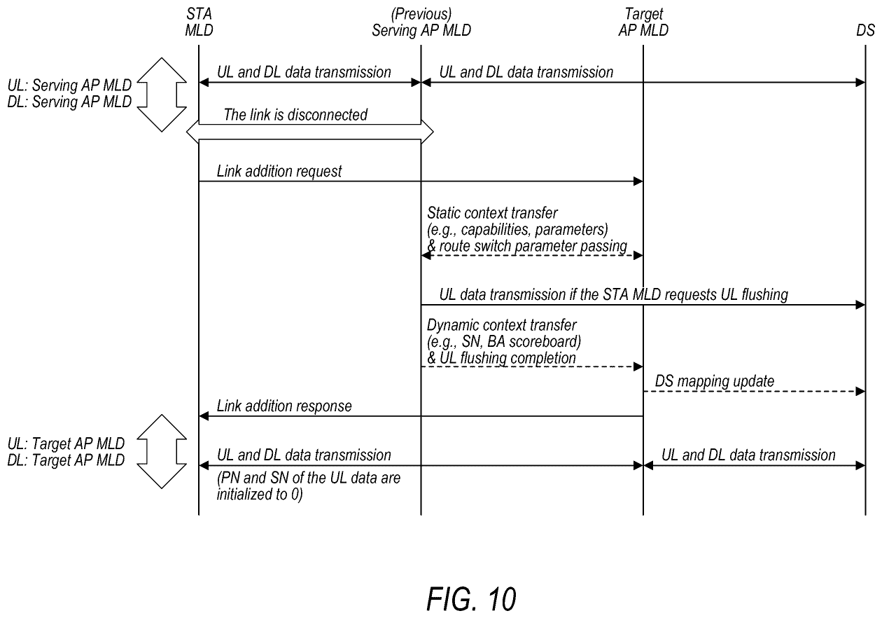

FIG. 10 is a signal flow diagram illustrating examples aspects of a unified link addition message exchange for a scenario in which the link with the serving AP MLD is disconnected without link addition request and response exchange for the target AP MLD having been performed through the serving AP MLD, according to some embodiments.

As shown, the STA MLD can initially perform uplink (UL) and downlink (DL) data transmission through the serving AP MLD. The link may become disconnected, and the STA MLD may accordingly provide a link addition request to the target AP MLD. The target AP MLD can perform static context transfer and route switch parameter passing with the serving AP MLD. The serving AP MLD can also perform UL data transmission if the STA MLD requests UL data flushing. The serving AP can further provide dynamic context transfer and an indication that UL flushing is complete. The target AP MLD can provide a DS mapping update to the DS, then provide a link addition response to the STA MLD. The STA MLD can then perform UL and DL data transmission (e.g., with PN and SN of the UL data initialized to 0, at least in some embodiments) through the target AP MLD. At this point the roaming operation may be complete and the target AP MLD can be considered the (new) serving AP MLD for the STA MLD.

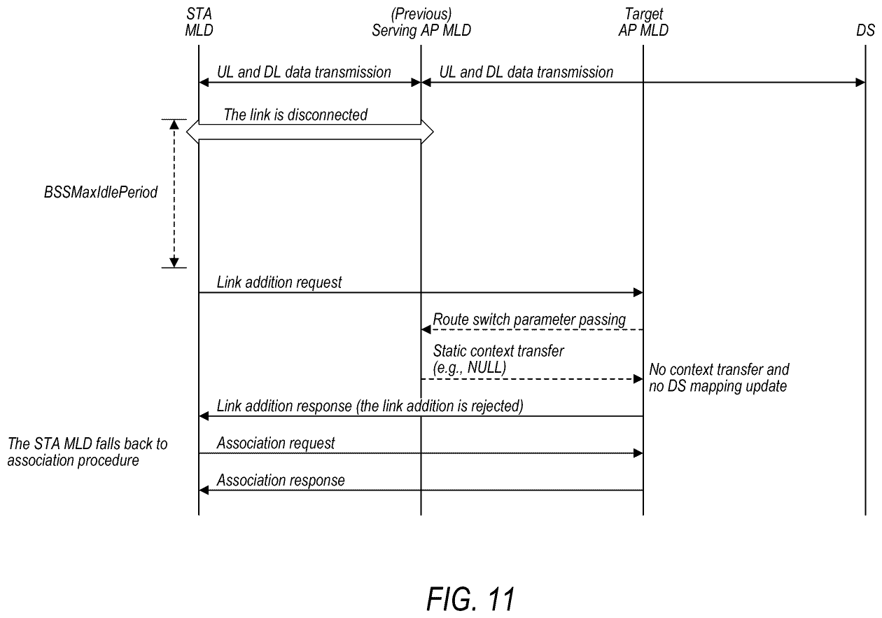

FIG. 11 is a signal flow diagram illustrating examples aspects of a unified link addition message exchange for a scenario in which the link with the serving AP MLD is disconnected and the MaxIdlePeriod has expired, according to some embodiments.

As shown, the STA MLD can initially perform UL and DL data transmission through the serving AP MLD. The link may become disconnected, and after the BSSMaxIdlePeriod expires, the STA MLD provides a link addition request to the target AP MLD. The target AP MLD can attempt to perform static context transfer and route switch parameter passing with the serving AP MLD, but the serving AP MLD has no context information (“NULL”) to provide. Accordingly, the target AP MLD can provide a link addition response that rejects the link addition request. The STA MLD can then fall back to an association procedure, e.g., including providing an association request to the target AP MLD and receiving an association response from the target AP MLD, as shown.

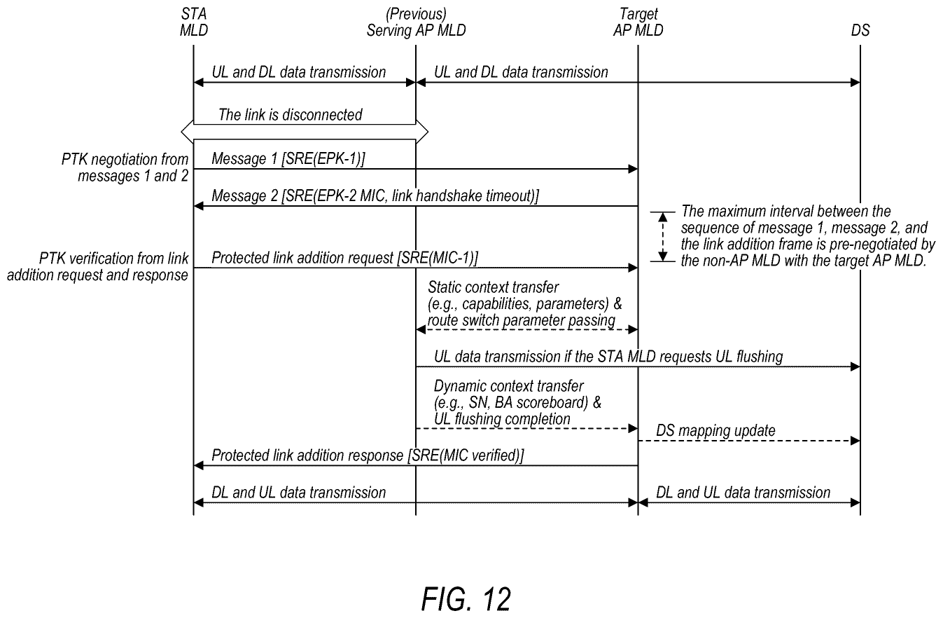

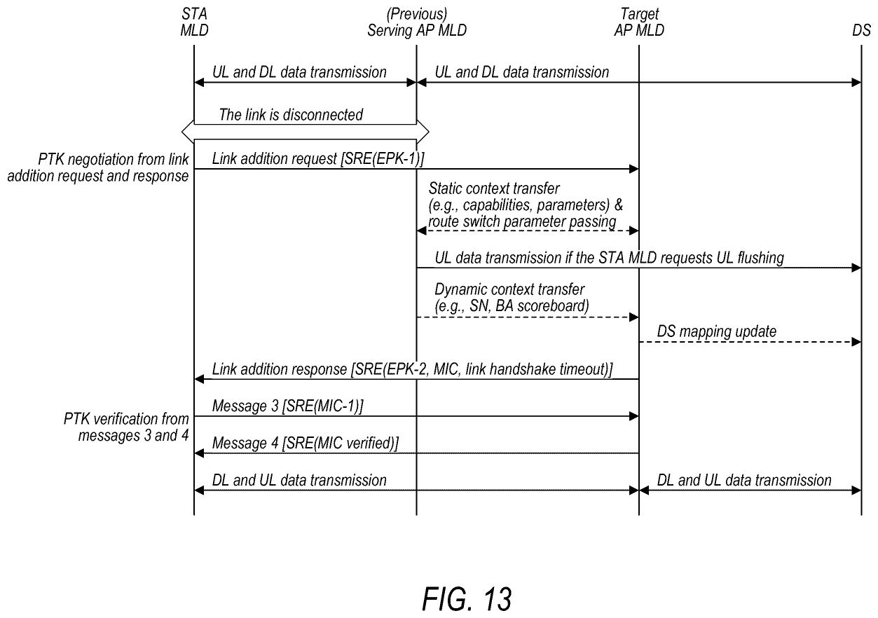

FIGS. 12-13 are signal flow diagrams illustrating examples aspects of possible protected unified link addition message exchanges for a scenario in which the link with the serving AP MLD is disconnected, according to some embodiments.

As shown, the STA MLD can initially perform UL and DL data transmission through the serving AP MLD. In FIG. 12, the link may become disconnected, and the STA MLD may exchange a “message 1” and “message 2” sequence with the target AP MLD for pairwise transient key (PTK) negotiation. The message 1 contains the first Encrypted Public Key 1 (EPK-1) generated by that STA MLD. The message 2 contains the second Encrypted Public Key (EPK-2) generated by the target AP MLD and MIC. The STA MLD can then provide a protected link addition request to the target AP MLD. The target AP MLD can perform static context transfer and route switch parameter passing with the serving AP MLD. The serving AP MLD can also perform UL data transmission to the Distribution System (DS) if the STA MLD requests UL data flushing. The serving AP can further provide dynamic context transfer and an indication that UL flushing is complete. The target AP MLD can provide a DS mapping update to the DS, then provide a protected link addition response to the STA MLD. The STA MLD can then perform UL and DL data transmission through the target AP MLD. Thus, PTK verification can be performed from the link addition and response exchange. Note that the maximum interval between the sequence of message 1, message 2, and the link addition request frame can be pre-negotiated by the non-AP MLD with the target AP MLD, in some embodiments.

In the scenario of FIG. 13, PTK negotiation is performed as part of the link addition request/response frame exchange. After the link addition request and response exchange, the STA MLD can exchange a “message 3” and “message 4” sequence with the target AP MLD for PTK verification. Note that in this case, however, that the link addition request/response frame exchange itself is not actually protected, e.g., since in this approach the PTK verification is not complete until the message 3 and message 4 exchange has been performed.

As noted previously herein, scenarios are also possible in which a STA MLD exchanges link addition request and response frames for the target AP MLD through the serving AP MLD, e.g., prior to disconnection with the serving AP MLD occurs. The STA MLD can determine that the link is disconnected if it observes a sudden drop in RSSI or a threshold of consecutive failures of UL frames is met, among various possibilities. In this case, the STA MLD can exchange the route switch request and response frames directly with the target AP MLD. The route switch request frame can be protected by the PTK established during the link addition procedure. The route switch request frame can include any or all of the serving AP MLD's MAC address (e.g., to request the transfer of dynamic context, such as SN, BA scoreboard, etc.), a UL packet flushing and/or DL data forwarding request for the serving AP MLD, and/or the DS mapping update at the target AP MLD. After sending the route switch request frame, it can be the case that the STA MLD can send UL data packets through the target AP MLD. However, it can be the case that the target AP MLD does not deliver the UL data packets until the serving AP MLD has completed the UL flushing. For the target AP MLD to recognize that the serving AP MLD has finished the UL flushing, the serving AP MLD can send an indication signal confirming the completion. Otherwise, the serving AP MLD can route the UL packet(s) via the target AP MLD. The route switch response frame can provide the status code and dynamic operating parameters (e.g., PNs of GTK, IGTK, BIGTK) of the target AP MLD, in some embodiments.

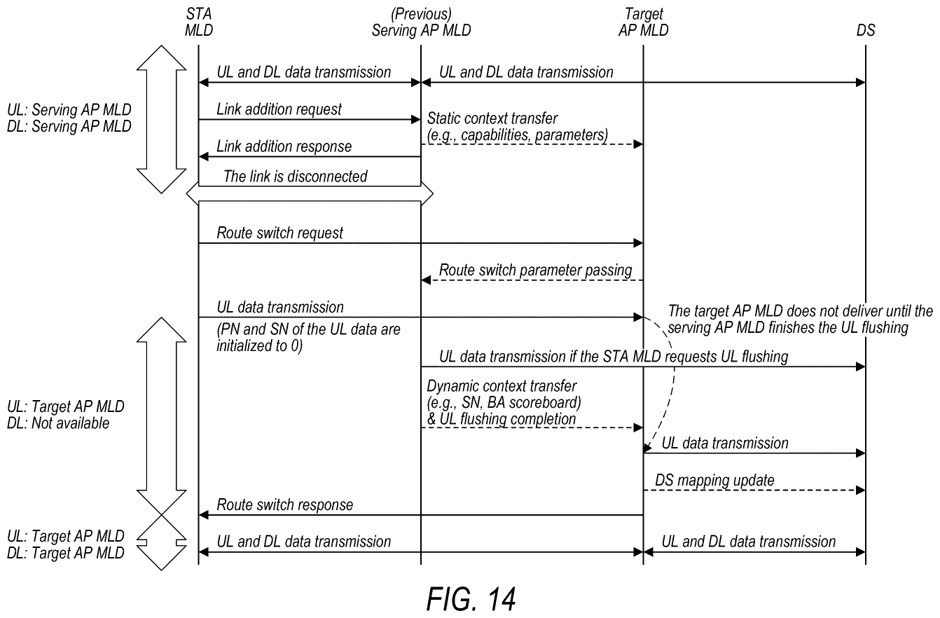

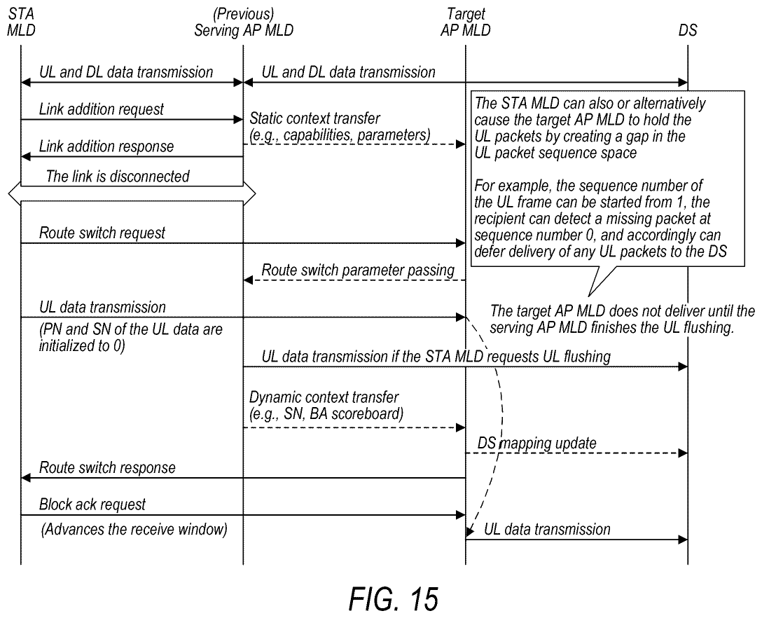

FIGS. 14-15 are signal flow diagrams illustrating example message exchanges for scenarios in which the link with the serving AP MLD is disconnected after link addition request and response exchange for the target AP MLD has been performed through the serving AP MLD, according to some embodiments. As shown in the scenario of FIG. 14, the STA MLD can initially perform UL and DL data transmission through the serving AP MLD, and additionally perform a link addition request and response with the serving AP MLD to perform link addition for the target AP MLD. The link may become disconnected, and the STA MLD may accordingly provide a route switch request to the target AP MLD. The target AP MLD can request route switch parameter passing with the serving AP MLD. The serving AP MLD can also perform UL data transmission to the DS if the STA MLD requests UL data flushing. The serving AP MLD can perform DL data packet forwarding to the target AP MLD if the STA MLD requests DL data forwarding. The STA MLD can perform UL data transmission through the target AP MLD (e.g., with PN and SN of the UL data initialized to 0, at least in some embodiments) during this time, and the target AP MLD can hold the UL data until after the UL data flushing from the serving AP MLD is complete. The serving AP MLD can provide dynamic context transfer and an indication that UL flushing is complete. The target AP MLD can release the held UL data, provide a DS mapping update to the DS, and provide a route switch response to the STA MLD. The STA MLD can then perform both UL and DL data transmission through the target AP MLD. In the scenario of FIG. 15, as an alternative or in addition to the target AP MLD being configured to hold UL data from the STA MLD until UL data is flushed from the serving AP MLD, the STA MLD can ensure that the target AP MLD holds the UL packets by creating a gap in the UL packet sequence space. For example, the STA MLD could start the sequence of the UL frames provided to the target AP MLD from 1. In this case, the target AP MLD can detect a missing packet at sequence number 0, and refrain from delivering any UL packets to the DS while the hole is present. Once the route switch is complete, the STA MLD can then provide a block acknowledgement request to the target AP MLD to advance the receive window, which can trigger release of the UL data and corresponding UL data transmission by the target AP MLD.

Note that, as another possibility, it can also be possible to use a unified link addition request/response exchange with the target AP MLD to perform seamless roaming after disconnection with the serving AP MLD even if link addition was already performed for the target AP MLD through the serving AP MLD. Such an approach may have a higher signaling overhead cost than an approach in which just route switch request and response exchange is performed in such a scenario, but can potentially reduce implementation complexity by avoiding the need to support different signaling exchange frameworks for performing seamless roaming after disconnection with the serving AP MLD depending on whether link addition was already performed for the target AP MLD through the serving AP MLD, at least according to some embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In addition to the above-described exemplary embodiments, further embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., an AP 104 or a STA 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for operation in wireless communication, comprising:
determining that a first wireless link with a serving access point is disconnected, wherein the first access point is associated with a first multi-link multi-device (MLMD);
transmitting, to a target access point that is associated with the first MLMD, based at least in part on determining that the first wireless link with the first access point is disconnected and the second access point being associated with the first MLMD, one or more of a link addition request or a route switch request; and
receiving, from the target access point, one or more of a link addition response or a route switch response.

2. The method of claim 1, wherein the method further comprises:
determining whether a maximum idle period has elapsed after the serving wireless link with the first access point is disconnected;
wherein transmitting one or more of a link addition request or a route switch request is further based at least in part on whether the maximum idle period has elapsed after the first wireless link with the serving access point is disconnected.

3. The method of claim 1,
wherein transmitting one or more of a link addition request or a route switch request comprises transmitting a unified link addition and route switch request,
wherein receiving one or more of a link addition response or a route switch response comprises receiving a unified link addition and route switch response.

4. The method of claim 3, wherein the method further comprises:
performing pairwise transient key (PTK) negotiation message exchange with the target access point before transmitting the unified link addition and route switch request,
wherein the unified link addition and route switch request and the unified link addition and route switch response comprise PTK verification information.

5. The method of claim 3,
wherein the unified link addition and route switch request and the unified link addition and route switch response comprise pairwise transient key (PTK) negotiation information, wherein the method further comprises:
performing PTK verification message exchange with the target access point after transmitting the unified link addition and route switch request and receiving the unified link addition and route switch response.

6. The method of claim 1, wherein the method further comprises:
performing, with the serving access point, before the first wireless link is disconnected, a link addition request and response exchange to add a second wireless link with the target access point;
wherein transmitting one or more of a link addition request or a route switch request comprises transmitting a route switch request based at least in part on the link addition request and response exchange to add the second wireless link with the target access point being performed before the first wireless link is disconnected.

7. The method of claim 1, wherein the method further comprises:
performing, with the serving access point, before the first wireless link is disconnected, a link addition request and response exchange to add a second wireless link with the target access point,
wherein transmitting one or more of a link addition request or a route switch request comprises transmitting a unified link addition and route switch request,
wherein receiving one or more of a link addition response or a route switch response comprises receiving a unified link addition and route switch response.

8. The method of claim 1, wherein the method further comprises:
transmitting, to the target access point, after transmitting one or more of a link addition request or a route switch request and before receiving one or more of a link addition response or a route switch response, uplink data.

9. The method of claim 8, wherein the method further comprises:
selecting a starting packet sequence number for the uplink data to provide a gap between a block acknowledgement window start and the starting packet sequence number for the uplink data; and
transmitting, to the target access point, after receiving one or more of a link addition response or a route switch response, based at least in part on the gap between the block acknowledgement window start and the starting packet sequence number for the uplink data, a block acknowledgement request to move a block acknowledgement window forward.

10. A processor comprising memory configured to cause the processor to perform operations comprising:
determining that a first wireless link with a serving access point is disconnected, wherein the serving access point is associated with a first multi-link multi-device (MLMD);
generating, for transmission to a target access point that is associated with the first MLMD, signaling that includes at least a request for a route switch from the serving access point to the target access point based at least in part on determining that the first wireless link with the serving access point is disconnected and based at least in part on the target access point being associated with the first MLMD; and
receiving, from the target access point, signaling that includes at least a response to the request for the route switch.

11. The processor of claim 10, wherein the memory is further configured to cause the processor to perform operations comprising:
determining whether a maximum idle period configured for the first MLMD has expired,
wherein generating the signaling that includes at least the request for the route switch is further based at least in part on whether the maximum idle period configured for the first MLMD has expired after the first wireless link with the serving access point is disconnected.

12. The processor of claim 10,
wherein the signaling that includes at least the request for the route switch comprises at least one of:
a link addition request;
a route switch request; or
a unified link addition and route switch request;
wherein the signaling that includes at least the response to the request for the route switch comprises at least one of:
a link addition response;
a route switch response; or
a unified link addition and route switch response.

13. The processor of claim 10,
wherein the signaling that includes at least the request for the route switch and the signaling that includes at least the response to the request for the route switch further comprise at least one of:
pairwise transient key (PTK) negotiation information; or
PTK verification information.

14. The processor of claim 10, wherein the memory is further configured to cause the processor to perform operations comprising:
generating, for transmission to the target access point after the signaling that includes at least the request for the route switch and before receiving the signaling that includes at least the response to the request for the route switch, uplink data;
wherein a starting packet sequence number for the uplink data is selected to provide a gap between a block acknowledgement window start and the starting packet sequence number for the uplink data; and
generating, for transmission to the target access point after receiving the signaling that includes at least the response to the request for the route switch, based at least in part on the gap between the block acknowledgement window start and the starting packet sequence number for the uplink data, signaling that includes a block acknowledgement request to move a block acknowledgement window forward.

15. A first access point (AP) wireless device, comprising:
one or more antennas;
one or more radios operably coupled to the one or more antennas; and
a processor operably coupled to the one or more radios;
wherein the first AP wireless device is configured to:
receive, from a non-AP wireless device, signaling that includes at least a request for a route switch to the first AP wireless device from a second AP wireless device, wherein the first AP wireless device and the second AP wireless device are associated with a first multi-link multi-device (MLMD);
provide, to the second AP wireless device, signaling that includes at least a request for context information for the non-AP wireless device; and
transmit, to the non-AP wireless device, signaling that includes at least a response to the request for the route switch.

16. The first AP wireless device of claim 15, wherein the first AP wireless device is further configured to:
receive, from the second AP wireless device, in response to the signaling that includes at least a request for context information for the non-AP wireless device, signaling that includes at least one of static context information or dynamic context information for the non-AP wireless device,
wherein the signaling that includes at least a response to the request for the route switch accepts the route switch request based at least in part on the signaling that includes at least one of static context information or dynamic context information for the non-AP wireless device.

17. The first AP wireless device of claim 15, wherein the first AP wireless device is further configured to:
receive, from the non-AP wireless device, after the signaling that includes at least the request for the route switch is received and before the signaling that includes at least the response to the request for the route switch is transmitted, uplink data.

18. The first AP wireless device of claim 17, wherein the first AP wireless device is further configured to:
receive, from the second AP wireless device, an indication that uplink data associated with the non-AP wireless device is flushed from the second AP wireless device; and
provide, to a distribution system, based at least in part on the indication that uplink data associated with the non-AP wireless device is flushed from the second AP wireless device, the uplink data received from the non-AP wireless device.

19. The first AP wireless device of claim 15,
wherein the signaling that includes at least the request for the route switch and the signaling that includes at least the response to the request for the route switch further comprise at least one of:
pairwise transient key (PTK) negotiation information; or
PTK verification information.

20. The first AP wireless device of claim 15, wherein the first AP wireless device is further configured to:
receive, from the second AP wireless device, in response to the signaling that includes at least a request for context information for the non-AP wireless device, signaling that includes at least an indication that no context information is available for the non-AP wireless device,
wherein the signaling that includes at least the response to the request for the route switch rejects the route switch request based at least in part on no context information being available for the non-AP wireless device.
